(19) United States
(12) Patent Application Publication
(10) Pub. No.: US 2024/0020618 A1
(43) Pub. Date: Jan. 18, 2024

(54) SYSTEM AND METHOD FOR SKILLS ONTOLOGY

(71) Applicant: ServiceNow, Inc., Santa Clara, CA (US)

(72) Inventors: Manjeet Singh, Hyderabad (IN); Eric E. Schroeder, La Jolla, CA (US); Jonathan Richard Crane, San Diego, CA (US)

(21) Appl. No.: 17/867,179

(22) Filed: Jul. 18, 2022

(51) Int. Cl. G06Q 10/06; G06F 16/36; G06F 40/279; G06F 40/211

(52) U.S. Cl. CPC G06Q 10/06398; G06Q 10/063112; G06F 16/367; G06F 40/279; G06F 40/211

(57) ABSTRACT

A skills ontology includes classes of data that define skills possessed or demonstrated by employees of an enterprise. Specifically, sets of data may be received and segmented into strings of text referred to as utterances. The utterances may be provided to an NLU service/engine, which uses NLU techniques to process the utterances to extract intents and/or entities. Skills may be identified from within the extracted entities. New skill records may be added to the skills ontology for newly extracted skills. Employee profiles of the skills ontology may also be updated based on the actions being performed. Further, the skills ontology may be utilized to identify employees having the skills associated with tasks to be performed and assign the task to an employee for completion. Once the task as been completed, skills profiles of the employee in the skills ontology may be updated to reflect performance of the task.

### BACKGROUND

The present disclosure relates generally to collecting, organizing, maintaining, and using information about an enterprise's employees. Specifically, the present disclosure relates to developing, maintaining, and utilizing a skills ontology.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g., computing devices, load balancers, firewalls, switches, etc.) and software resources (e.g., productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing-based services. By doing so, users are able to access computing resources on demand that are located at remote locations, which resources may be used to perform a variety computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

In modern communication networks, examples of cloud computing services a user may utilize include so-called infrastructure as a service (IaaS), software as a service (SaaS), and platform as a service (PaaS) technologies. IaaS is a model in which providers abstract away the complexity of hardware infrastructure and provide rapid, simplified provisioning of virtual servers and storage, giving enterprises access to computing capacity on demand. In such an approach, however, a user may be left to install and maintain platform components and applications. SaaS is a delivery model that provides software as a service rather than an end product. Instead of utilizing a local network or individual software installations, software is typically licensed on a subscription basis, hosted on a remote machine, and accessed by client customers as needed. For example, users are generally able to access a variety of enterprise and/or information technology (IT)-related software via a web browser. PaaS acts an extension of SaaS that goes beyond providing software services by offering customizability and expandability features to meet a user's needs. For example, PaaS can provide a cloud-based developmental platform for users to develop, modify, and/or customize applications and/or automating enterprise operations without maintaining network infrastructure and/or allocating computing resources normally associated with these functions.

In operating an enterprise, decisions may be made and actions taken based on incorrect assumptions as to which employees of the enterprise have what skills, resulting in inefficiencies in the enterprise's operations. Accordingly, it may be desirable to develop techniques for collecting and maintaining more accurate data representing skills possessed by employees of the enterprise in order to make the operations of the enterprise more efficient.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure is directed to generating, maintaining, and utilizing a skills ontology. The skills ontology includes classes of data that define skills possessed or demonstrated by employees of an enterprise. Specifically, sets of internal data (e.g., data generated within the organization) and/or external data (data generated outside of the organization) may be received and segmented into strings of text referred to as utterances. The utterances may be provided to an NLU service/engine, which uses NLU techniques to process the utterances to extract intents and/or entities. Skills may be identified from within the extracted entities. If extracted skills had not previously been included in the skills ontology, records for the new skills may be created and included in the ontology. If the received data is representative of actions that have been performed, or other activity that has occurred in the past, the skills ontology may be updated based on the skills extracted from the received data by associating the extracted skills with employees that performed the actions. This may include, for example, updating a skills profile for the employee within the skills ontology. If the data is representative of tasks to be performed, the skills ontology may be utilized to identify employees having the extracted skills and assign the task to one or more employees for completion. Once the task as been completed, the skills profiles of the one or more employees in the skills ontology may be updated to reflect performance of the task. Further, the skills ontology may be used to identify skills gaps or areas for improvement for an employee, assign training for the identified skills, monitor when the training has been completed, and then update the skills profile of the employee in the skills ontology to reflect completion of the training. The skills ontology may also be utilized to identify skills shortages and/or skills surpluses within the enterprise so that decisions can be made to move some employees to different jobs, promote some employees, demote some employees, create new jobs to be filled, terminate certain jobs, train existing employees to assume different jobs, and so forth. Accordingly, the disclosed techniques utilize NLU techniques to extract skill data from available data and utilize the skill data to increase the efficiency of some of the enterprise's operations.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is a schematic illustrating sources of skill data for a skill ontology, in accordance with aspects of the present disclosure;

FIG. 6 is a schematic illustrating a framework for utilizing internal and external skill data within an enterprise to populate, maintain, and utilize the skills ontology, in accordance with aspects of the present disclosure;

FIG. 7 is a schematic illustrating an embodiment in which an NLU service is used to extract skills from the skill data, in accordance with aspects of the present disclosure;

FIG. 8 is a flow chart illustrating how skills are extracted from incident data, in accordance with aspects of the present disclosure;

FIG. 9 is a schematic illustrating a taxonomy on which the skills ontology is built, in accordance with aspects of the present disclosure;

FIG. 10A illustrates two skills records stored in the skills ontology of FIG. 9, in accordance with aspects of the present disclosure;

FIG. 10B illustrates two employee records stored in the skills ontology of FIG. 9, in accordance with aspects of the present disclosure;

FIG. 11 is a visualization of data stored in the skills ontology for a job family called “product management”, in accordance with aspects of the present disclosure;

FIG. 12 illustrates an employee-focused manager dashboard that is populated based on data stored in the skills ontology, in accordance with aspects of the present disclosure;

FIG. 13 illustrates a team-focused manager dashboard that is populated based on data stored in the skills ontology, in accordance with aspects of the present disclosure;

FIG. 14 is a flow chart of a process for extracting skills from received data and updating the skills ontology, in accordance with aspects of the present disclosure;

FIG. 15 is a flow chart of a process for extracting skills from received data and associating the extracted skills with employees, in accordance with aspects of the present disclosure;

FIG. 16 is a flow chart of a process for extracting skills from tasks and assigning tasks to employees, in accordance with aspects of the present disclosure;

FIG. 17 is a flow chart of a process for developing a training program for employees, in accordance with aspects of the present disclosure; and

FIG. 18 is a flow chart of a process for identifying and addressing skill shortages and/or surpluses in an organization, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code. As used herein, the term “configuration item” or “CI” refers to a record for any component (e.g., computer, device, piece of software, database table, script, webpage, piece of metadata, and so forth) in an enterprise network, for which relevant data, such as manufacturer, vendor, location, or similar data, is stored in a CMDB. As used herein, the terms alerts, incidents (INTs), changes (CHGs), and problems (PRBs) are used in accordance with the generally accepted use of the terminology for CMDBs. Moreover, the term “issues” with respect to a CI of a CMDB collectively refers to alerts, INTs, CHGs, and PRBs associated with the CI.

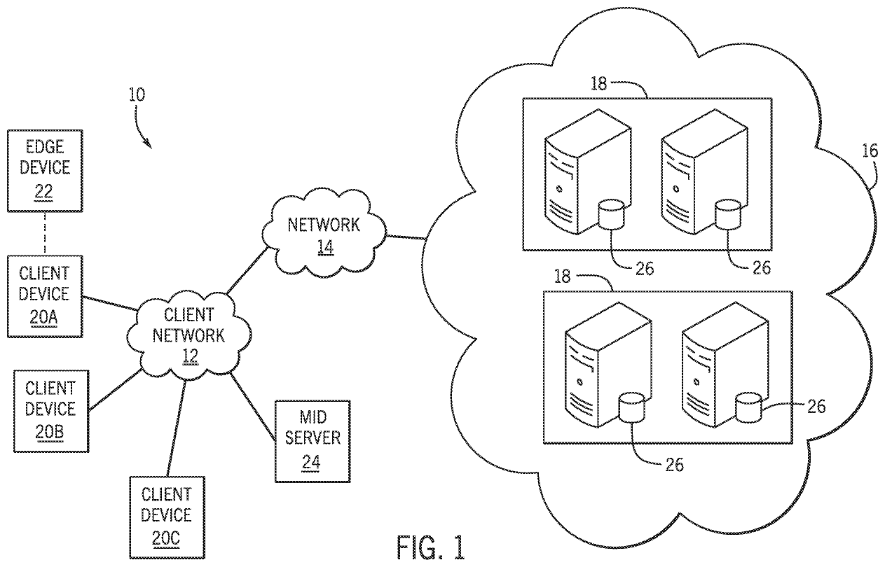

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

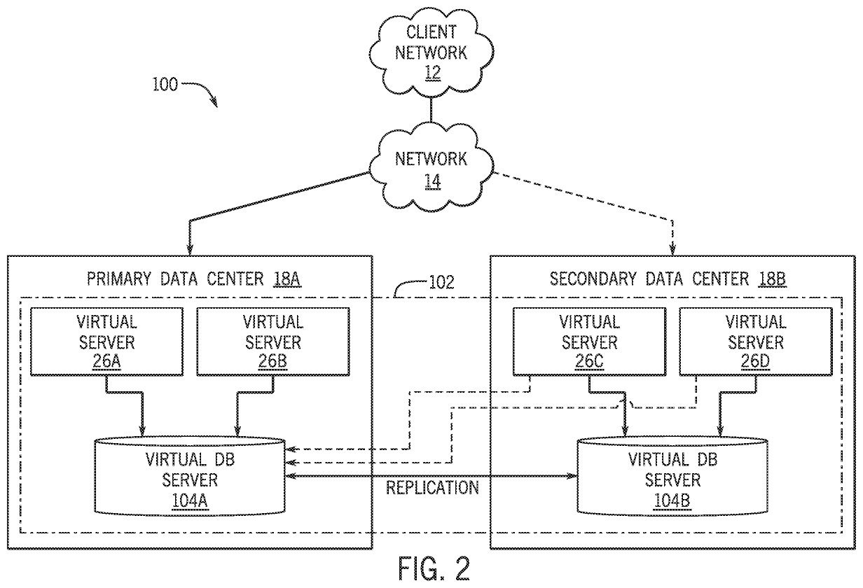

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

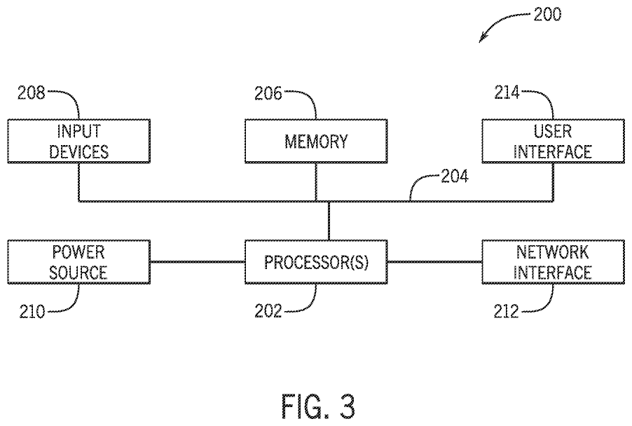

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

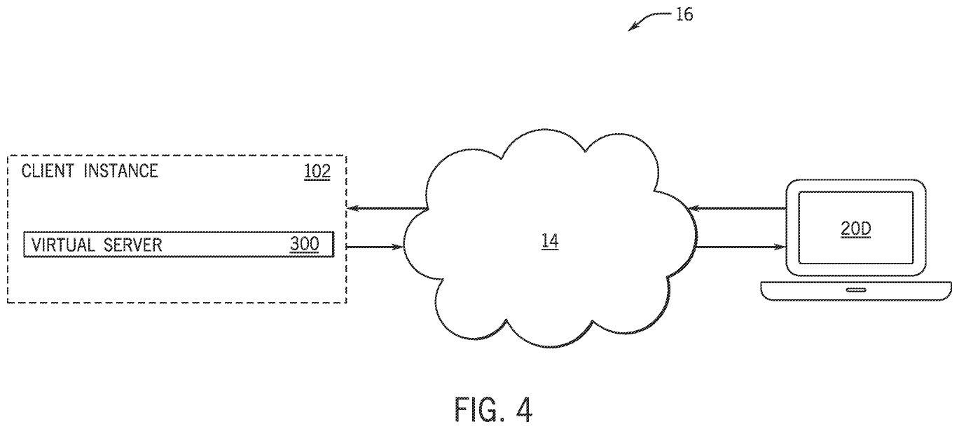

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20D via the network 14 to provide a user interface to network applications executing within the client instance 102 (e.g., via a web browser of the client device 20D). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20D, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

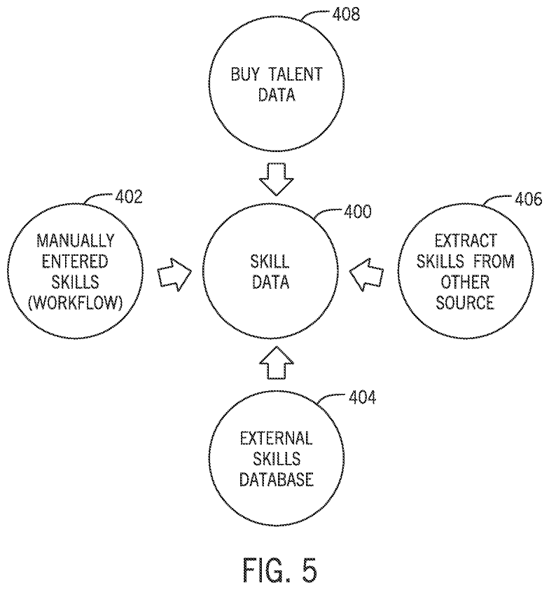

Returning to FIG. 1, the cloud-based platform 16 may be used to monitor and/or manage activities performed by an enterprise or organization that operates the client network 12. For example, the cloud-based platform 16 may be used to manage an information technology (IT) team for the enterprise, an IT helpdesk, a call center, a software development team, a product development team, an accounting team, a compliance team, human resources (HR) activities, purchasing and requisition activities, recruiting activities, documents/file management activities, customer relations, vendor management, logistics, security, employee training activities, employee promotions and/or performance reviews, employee compensation management, benefits management, and so forth. Accordingly, having more complete data about employees, such as their skills, experience, skills gaps, preferences, goals, history, etc. enables the enterprise to make better decisions about who to assign what tasks, what training to recommend for an employee, whether an employee would be a good candidate for a promotion or an open position, and so forth. With this in mind, FIG. 5 is a schematic illustrating a few possible sources of skill data 400. At 402, the enterprise may use manually entered skill data that defines skills possessed and/or demonstrated by employees of the enterprise. For example, the manually entered skill data may define skills such as programming in Python, customer service skills, leadership skills, mentoring skills, IT troubleshooting skills, understanding network infrastructure, understanding machine learning, proficiency in databases, proficiency in certain software applications, foreign language skills, and so forth. The manually entered skill data may be entered by employees themselves, managers, direct reports, administrative professionals, administrators, dedicated data entry professions, and so forth. Further, manually entered data defining various skills may be pulled directly from, or based on data pulled from, evaluations, incident/task records, project record, HR records, and so forth.

At 404, the enterprise may subscribe to or otherwise have access to an external skills database that includes skill data organized according to some pre-determined skill framework. As such, skills defined by the external skills database may not be unique to a particular enterprise, but rather be universal or widely held across many organizations (e.g., proficiency in a particular word processing software), across an industry (e.g., proficiency in programming in Python), across organizations of a certain size (e.g., proficiency in accounting software), across a region (e.g., proficiency in a given language or business laws/regulations in a given jurisdiction), and so forth. In some embodiments, the external skills database may be a global skills database, intended for organizations across many industries, organizations of any size, organizations in many regions/locations, etc. The enterprise may download the whole external skills database, or just specific data the enterprise is interested in or finds useful.

At 406, the enterprise may extract data from internal and/or external data sources and generate skills based on the extracted data. Internal data sources may include job descriptions, job postings, employee performance reviews, incident data, help ticket data, HR data, project data, proposal data, vendor/supplier contract data, government regulatory data, training data, and so forth. External sources of the data may include social media, online job postings, message boards, blog posts, articles in print/online publications, etc. For example, the enterprise may collect data from various sources and then extract skills from the collected data. The collected data may form a corpus of data to which various algorithms (e.g., machine learning algorithms) are applied to extract specific skills, and in some cases attributes of the extracted skills.

At 408, the enterprise may purchase a set of talent data from an external source. Unlike the external skills database, the purchased data may be a one-time download of data, rather than access to a frequently updated database. Further, the purchased talent data may or may not be organized accordingly to some pre-defined skill framework. Accordingly, in some embodiments, the enterprise may apply one or more algorithms to the purchased talent data to extract one or more skills form the purchased data. As such, in some embodiments, using purchased talent data may have some similarities to accessing the external skills database (at 404) and/or extracting skills from other sources (at 406). As used herein, the term “external data” may refer to any of 404, 406, and 408, or a combination thereof. Though four sources of data are shown in FIG. 5, it should be understood that FIG. 5 is not intended to be limiting and that other sources of data are envisaged.

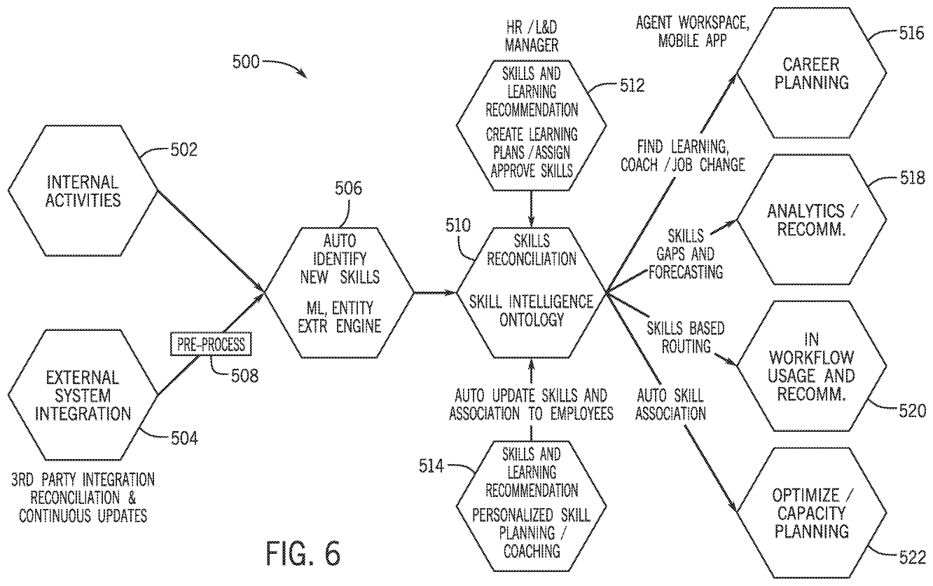

FIG. 6 is a schematic illustrating a framework 500 for utilizing internal and external skill data within an enterprise. As shown, internal data 502 and external data 504 are provided to a machine learning-based entity extraction engine 506. As previously described with regard to FIG. 5, the internal data is data that is generated or modified by the enterprise and may include, for example, data pulled from job descriptions, job postings, employee performance reviews, incident data, help ticket data, HR data, project data, proposal data, vendor/supplier contract data, government regulatory data, training data, completed tasks, completed training, and so forth. External data is data that originates from outside the enterprise and may include, for example, social media, online job postings, message boards, blog posts, articles in print/online publications, information pulled from public databases, information pulled from the Internet, etc. In some embodiments the external data 504 may go through a pre-processing phase, either before reaching the entity extraction engine 506, or as a part of the entity extraction engine 506. While the internal data 502 may be in a finite number of known formats, the external data 504 may arrive in a wide range of formats, most, or all, of which may not be previously known. As such, the pre-processing step may include applying one or more algorithms to the external data 504 to put the external data into known formats that are the same or similar to the formats of the internal data 502.

The machine learning-based entity extraction engine 506 uses natural language understanding techniques (NLU), or provides data (e.g., the internal data 502 and the external data 504) to an NLU service, to extract entities from the internal data 502 and the external data 504. Extracting entities may include, for example, breaking the data 502, 504 into snippets that are treated as utterances, generating word vectors, phrase vectors, sentence vectors, paragraph vectors, utterance trees, etc., relating vectors to one another in vector space, extracting entities based on the vectors, referencing ontologies, dictionaries, and/or databases, and associating entities with skills. The entity extraction engine 506 may then compare the extracted skills to known skills stored in an ontology to determine if any new skills have been extracted. The extracted skills, and contextual data about the extracted skills, are sent to a skill intelligence ontology component 510 that manages a skill ontology. The skill ontology is a framework that includes concepts and categories associated with skills for an enterprise, properties of those concepts, categories, and skills, as well as relationships between the concepts, categories, and skills. The skill intelligence ontology component 510 receives the extracted skills and the contextual data and updates the skill ontology to include the newly extracted skills and update the existing skills based on new data. As will be discussed in more detail below, the skill ontology also includes information about employees of the enterprise and what skills they possess.

In some embodiments, an enterprise skill planning component 512 may receive new skills for approval from the skill intelligence ontology component 510. That is, new extracted skills may be considered for approval by a subject matter expert (SME), a learning and development manager, a human resources team member, a supervisor, a manager, a project lead, and so forth. Accordingly, the enterprise skill planning component 512 may send approvals, rejections, and/or modifications of new skills to the skill intelligence ontology component 510 for inclusion in the enterprise's skill ontology. In some cases, the skill intelligence ontology component 510 may also request approvals from supervisors confirming that employees actually have skills in question. Additionally, the skill intelligence ontology component 510 may generate learning plans for developing new skills as employees progress along common paths through an organization. For example, learning plans may include plans for learning a specific set of skills as a new employee is onboarded, as an employee joins a specific team (e.g., software development, accounting, IT, etc.), as an employee moves from being a contractor to a full-time employee, as an employee moves from a first team to a second team, as an employee moves up an organizational chart of the enterprise (e.g., becomes a supervisor, a manager, a project lead, a director, vice president, executive, etc.), as an employee moves to a different region or office, and so forth.

Further, a personalized skill planning component 514 may generate coaching or skill development plans for individual employees based upon their goals, their strengths skill gaps, avenues for upward mobility, etc. The skill development plans for individual employees may be received by the skill intelligence ontology component 510 and the skill ontology may be updated based on trends identified in the received skill development plans. Employee profiles in the skill ontology may be updated to reflect goals. In some embodiments, the personalized skill planning component 514 may also confirm whether employees actually possess skills in questions based on the extracted data.

The skill ontology for the enterprise may be available for performance of various functions within the enterprise, such as career planning 516, analytics/recommendations 518, workflow usage 520, and optimization/capacity planning 522. For career planning 516, employees may use an agent workspace or mobile application to manage a profile by setting goals, providing information about skills, achievements (e.g., awards, certifications, etc.), experiences, communicating interest in holding particular positions in the future, providing feedback to the enterprise, etc. For analytics 518, the enterprise may utilize the skill ontology to identify skills and/or skills gaps of individual employees, recommend training to close skills gaps, and forecast skill development of particular employees. These may be communicated to the employee via an agent workspace or mobile application. Similarly, dashboards including information about employee skills and skill gaps may be provided to supervisors, managers, vice presidents, executives, etc. via a workspace or mobile application. For workflow usage 520, the enterprise may utilize the skills ontology to identify skills associated with a particular task, identify one or more agents having the identified skills, and routing the task to one or the identified agents. For optimization/capacity planning 522, the enterprise may use the skills ontology for department/organization/enterprise-level analysis for determining how to optimize the operations of the organization, identify where to hire more employees, capacity planning, etc.

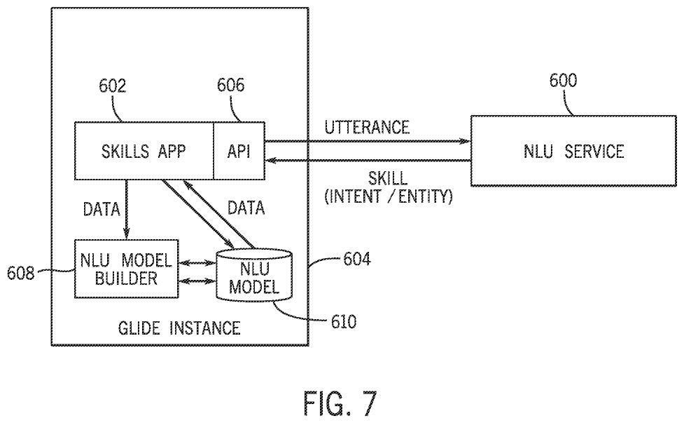

FIG. 7 is a schematic illustrating an embodiment in which an NLU service 600 is used to extract skills from internal and/or external data. As shown, a skills application 602 runs on a glide instance 604 and communicates with the NLU service 600 via an application programming interface (API) 606. The glide instance utilizes the API 606 to perform database operations without the user writing SQL queries. The skills application 602, via the API 606, sends utterances (e.g., segments of text data from the internal and/or external data discussed with regard to FIGS. 5 and 6) to the NLU service 600. The NLU service 600 processes the utterances to extract intents and/or entities, which are transmitted back to the skills application 602, via the API 606, as extracted skills. In some embodiments, the received responses may be processed to identify skills. The skills application 602 provides the extracted skills to an NLU model builder, which uses the extracted skills to build and/or update an NLU model 610. The skills application 602 may interact with the NLU model 610 based on the extracted intents/entities/skills received from the NLU service 600 (e.g., to identify skills within returned entities). For example, the skills application 602 may provide some or all of the extracted intents/entities/skills received from the NLU service 600 to the NLU model 610 and the NLU model 610 may return data to the skills application 602 that provides additional information, such as extracted skills, contextual information, related skills, employees having the extract skills, and so forth.

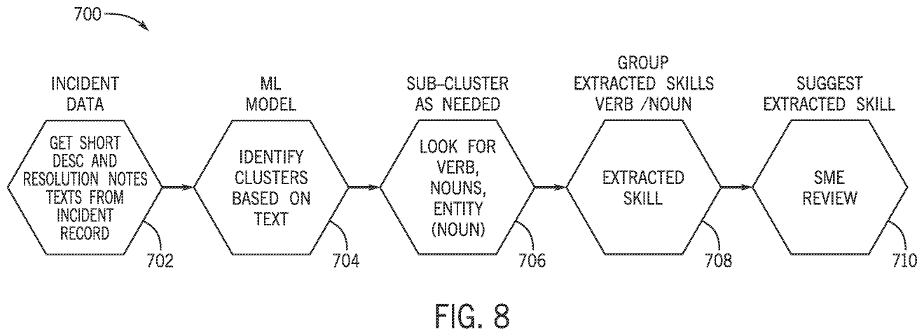

FIG. 8 is a flow chart illustrating how skills are extracted from incident data. At 702, incident data is retrieved, for example, by the skills application 602 shown and described with regard to FIG. 7. The incident data retrieval may include, for each of one or more incident records, retrieving a short description, detailed description, resolution notes, and/or other fields from the incident record. The short description and detailed description may be provided by a user/customer or based on data provided by the user/customer. The resolution notes are created by the agent that resolved the incident and describe what was done to resolve the incident and, in some cases, other actions taken that did not resolve the incident. At 704, the incident data is segmented into utterances and transmitted to a machine learning model that processes the incident data. In some embodiments, the machine learning may be part of the skills application 602 shown and described with regard to FIG. 7 or otherwise running on the glide instance 604 shown and described with regard to FIG. 7. In other embodiments, the machine learning model may be part of the NLU service 600. In processing the incident data, the machine learning model may analyze the text of the incident data and identify clusters of characters, character strings, groups of character strings, words, groups of words, phrases, sentences, etc. in the incident data. For example, the NLU service 600 may generate an utterance tree for each utterance. The utterance trees represent the structure (e.g., syntactic structure) of the corresponding utterance. The utterance trees have nodes that include word vectors representing words in the utterance. A tree vector is generated for each tree based on the word vectors of the nodes in the tree. Intents and entities are extracted from the utterance by comparing the tree vector and/or the individual word vectors to one or more dictionaries, one or more tree vector ontologies, one or more word vector ontologies, one or more databases of known word vectors, or other available data sources. At 706, the machine learning model may identify sub-clusters of the incident data as needed by processing particular clusters of characters, character strings, groups of character strings, words, groups of words, phrases, sentences, etc. to identify verbs, nouns, entities, skills, etc. in the incident data. Identifying verbs, nouns, entities, skills, etc. in the incident data may be based on identifying particular character strings or words, using context (e.g., the words around the word in question, where the word in question falls in the sentence, etc.), and so forth. For example, the NLU service may generate utterance subtrees for utterances having multiple clauses or phrases. The utterance trees represent the structure (e.g., syntactic structure) of the corresponding utterance. As with the utterance trees, the utterance subtrees may be made up of nodes that include word vectors representing words in the utterance. A subtree vector is generated for each subtree based on the word vectors of the nodes in the subtree. Intents and entities are extracted from the utterance by comparing the tree vector, subtree vector, and/or the individual word vectors to one or more dictionaries, word vector ontologies, databases of known word vectors, or other available data sources.

At 708, skills are extracted based on the identified skills and/or by associating the identified verbs, nouns, entities, etc. with known skills and/or newly generated skills. The extracted entities/skills are transmitted from the NLU service to the skills application via the API. In some embodiments, the skills may be identified from within the extracted entities. If the extracted entities/skills include new skills, the new skills may be presented to a subject matter expert (SME) for review and approval. For example, the skills application may generate and transmit a notification or message for an SME (e.g., a supervisor, a manager, a training specialist, a learning and development manager, a project lead, etc.) for review and approval. If the newly extracted skills are approved, the ontology may be updated to include the newly extracted skills, along with indications that the newly extracted skills are held by one or more employees. It should be understood, however, that sometimes newly extracted skills may be automatically added to an ontology without approval/review or automatically approved by, for example, referencing an internal or external data source to verify a skill.

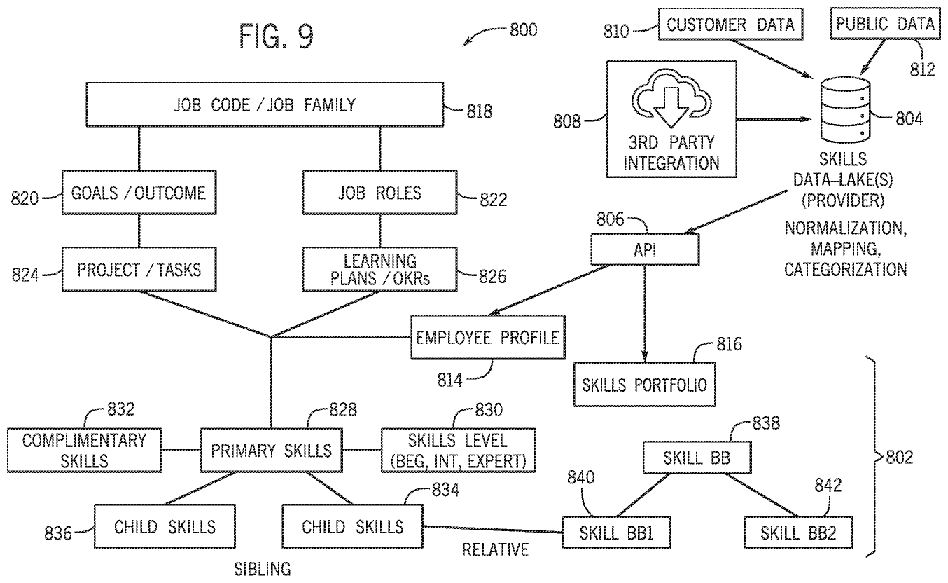

FIG. 9 is a schematic illustrating a taxonomy 800 on which a skills ontology 802 is built. The taxonomy 800 is a semantic classification scheme that identifies hierarchical relationships among concepts. The skills ontology 802 identifies concepts within the taxonomy 800 and the relationships between the concepts within the enterprise. As shown, an enterprise accesses a provider-managed skills data lake 804 and retrieves data from the skills data lake 804 via an API 806. The skills data lake 804 includes information about various skills (e.g., foreign language skills, proficiency in certain software packages, programming in specific software languages, etc.) and how those skills may be related to one another. The provider may generate and update/maintain the skills data lake 804 based on data from third parties 808, customer data 810, public data 812, and/or other data sources. Data from third parties 808 may be obtained, for example, via third party integrations, such as, for example, social media data, mobile application usage data, job posting data, financial transaction data, location data, and so forth. Customer data may include, for example, anonymized data received from customers regarding skills possessed and/or demonstrated by their employees and how to identify that someone has such skills. Public data may include, for example, data available on the internet, public databases, government data, data published by various organizations (e.g., non-profit organizations, training organizations, professional organizations, etc.) and so forth. It should be understood, however, that these data sources are merely an example and that embodiments are envisaged in which data is pulled from other sources.

In some embodiments, the provider may provide access to a single data lake for all of its customers. In other embodiments, the provider may generate and maintain multiple data lakes to which it provides access for its customers. For example, the service provider may maintain data lakes for customers in specific industries (e.g., software development, aerospace, military, finance/banking, consumer products, healthcare, manufacturing, food and beverage, cosmetics, restaurants, retail, etc.), data lakes for customers of certain sizes (e.g., single location, local chain, regional chain, national chain, multinational organization, number of employees, number of locations, etc.), data lakes for customers in specific locations/regions (e.g., city, state, region, country, etc.). In some embodiments, the service provider may provide access to one or more specific data lakes 804 and a general-purpose data lake 804.

Data retrieved from the provider data lake 804 via the API 806 may be used to populate the skills ontology 802 via one or more employee profiles 814 and one or more skills portfolios 816. Each employee profile 814 includes information about a respective employee. For example, the employee profile may include identifying information about the employee, the job the employee holds, responsibilities assigned to the employee, biographical information, past jobs, skills the employee has, teams the employee is a part of, certifications the employee has, the office location at which the employee works, the employee's supervisors, the employee's direct reports, extracurricular activities, and so forth. The skills portfolio 816 may include information about skills possessed and/or demonstrated by employees of the enterprise, as well as skills the enterprise has identified as being interested in tracking. The skills portfolio includes information defining which skills are primary skills, which skills are complementary skills, the various skills levels (e.g., beginner, intermediate, advanced, expert, etc.), relationships between skills (e.g., grandparent, parent, child, grandchild, sibling, relative, etc.), and so forth.

As shown in FIG. 9, the taxonomy 800 includes classes and subclasses of data that may be defined by tables of one or more databases. For example, as shown in FIG. 9, a job code/job family class 818 includes a goals/outcomes subclass 820 and a job roles subclass 822. The goals/outcomes subclass 820 defines goals and/or desired outcomes for a respective job associated with a job code. The job roles subclass 822 defines roles associated with a respective job associated with a job code. The job code/job family class 818 further includes a projects/tasks subclass 824 and a learning plans/OKRs subclass 826. The projects/tasks subclass 824 defines projects and tasks assigned to a respective job associated with a job code. The learning plans/OKRs subclass 826 defines training (e.g., learning plans), as well as objectives and key results for a respective job associated with a job code.

A primary skills class 828 defines skills possessed and/or demonstrated by employees in which each skill possessed and/or demonstrated by an employee is represented as a record stored in one or more tables. As is shown and described below, the record may also include other information about the employee such as, for example, their name, and employee identification number, employer, job title, job family, industry, years of experience, job roles, skills possessed/demonstrated, descriptions of those skills, respective proficiency level at skills, related skills, and so forth. The complementary skills class 832 defines skills that are complementary to skills represented in the primary skills class 828. For example, proficiency programming in JAVA may be commentary to proficiency in programming in HTML and/or proficiency programming in Python. Accordingly, complementary skills may be related in some way, but may not have a parent/child and/or nested relationship.

Child skill classes 836, 834 define skills that have a parent/child relationship with skills in the primary skills class 828. For example, a skill in the primary skills class 828 may be software development, whereas skills in the child skill classes 836, 834 may include, for example, programming in JAVA, Python, HMTL, C#, and so forth. Skills in different child skill classes 836, 834 that share a parent primary skills class 828 are considered sibling skills. Sibling skills may or may not also be considered complementary skills. Though FIG. 9 only shows parent and child levels of skills classes, it should be understood that skill ontologies having multiple levels of parent/child relationships are envisaged. Accordingly, skills may have great-great grandparents, great grand parents, grand parents, parents, children, grandchildren, great grand children, great-great grand children, and so forth.

A skill levels class 830 defines various skill levels of skills possessed and/or demonstrated by the employee. An employee's proficiency at a given skill may be captured by skill levels, scores (e.g., 1-3, 1-5, 1-10, 1-50, 1-100, etc.), binary (e.g., yes or no), or some other quantitative or qualitative (e.g., skill badges) measure.

The skill BB class 838 shown in FIG. 9 represents another skills class, separate from, and not directly related to, the primary skills class 828. As shown, the skill BB class 838 has child classes that include a skills BB1 class 840 and a skills BB2 class 842. As illustrated, the skills BB1 class 840 is related to the child skills class 834. Accordingly, the skills BB1 class 840 and the child skills class 834 may include skills that are related to one another, but whose parent classes are not related to one another. For example, the child skills class 834 may include skills related to proficiency in programming certain software language and the skills BB1 class 840 may include skills associated with using a debugging software package or cloud-based document management service used to store software code. It should be understood, however, that the taxonomy 800 and skills ontology 802 shown in FIG. 9 are intended to be simplified examples for the sake of illustration and that actually implemented taxonomies 800 and skills ontologies 802 may be more complex than is shown in FIG. 9. Accordingly, taxonomies 800 and skills ontologies 802 may have more levels, more related classes, and more complex relationships than is shown in FIG. 9.

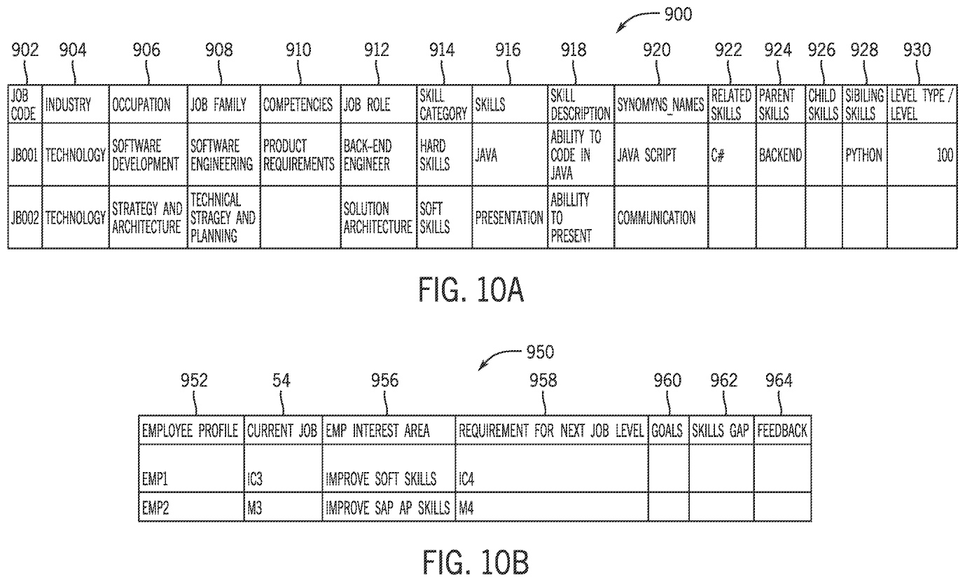

FIGS. 10A and 10B illustrate example records stored in the skills ontology 802 shown in FIG. 9. Specifically, FIG. 10A illustrates two skills records 900 stored in the skills ontology 802 shown in FIG. 9. As shown, the skills records 900 include a job code field 902, an industry field 904, an occupation field 906, a job family field 908, a competencies field 910, a job role field 912, a skill category field 914, a skill field 916, a skill description field 918, a skill synonyms field 920, a related skills field 922, a parent skills field 924, a child skills field 926, a sibling skills field 928, and a skill level type/level field 930.

The job code field 902 identifies a job code associated with job held by the employee that possesses the skill. The industry field 904 identifies the industry to which the job held by the employee that possesses the skill pertains. The occupation field 906 identifies the general occupation to which the job held by the employee that possesses the skill belongs. The job family field 908 identifies the family of jobs to which the job held by the employee that possesses the skill belongs. The competencies field 910 identifies the competencies held by the employee that possesses the skill, or the competencies that the employee that possesses the skill can be assumed to have based upon the employee possessing the skill. The job role field 912 identifies roles associated with the job held by the employee that possesses the skill. The skill category field 914 identifies one or more categories to which the skill in question belongs. The skill field 916 identifies the skill in question. The skill description field 918 includes a description of the skill in question. The skill synonyms field 920 identifies possible synonyms, if any for the skill in question. The related skills field 922 identifies one or more skills, if any, that may be related to the skill in question. The parent skills field 924 identifies one or more skills, if any, that may be parent skills to the skill in question. The child skills field 926 identifies one or more skills, if any, that may be child skills to the skill in question. The sibling skills field 928 identifies one or more skills, if any, that may be sibling skills to the skill in question. The skill level type/level field 930 identifies the type of skill level by which the skill in question is assessed, and/or the levels of proficiency for the skill in question. It should be understood, however, the skill records 900 shown in FIG. 10A are merely examples and that embodiments are envisaged in which the fields have different values, the records have additional fields, fewer fields, and/or different fields.

FIG. 10B illustrates two employee records 950 stored in the skills ontology 802 shown in FIG. 9. As shown, the employee records 950 include an employee profile field 952, a current job field 954, an employee interest area field 966, a requirement for next job level field 958, a goals field 960, a skills gap field 962, and a feedback field 964. The employee profile field 952 includes an employee name, identification number, social security number, or other identifying information. The current job field 954 identifies the employee's current job. The employee interest area field 966 identifies one or more areas of interest for the employee. The areas of interest may be taken into account when considering new skills to suggest, recommended training, new jobs, geographical relocations, promotions, open positions within the organization, fit with clients/customers, fit with managers/supervisors and/or direct reports, and so forth. The requirement for next job level field 958 identifies requirements for the next job to which the employee may be promoted or otherwise moved. This may be based, for example, upon the next job up an organizational chart, a job identified as desired by the employee, a common or previous path through the organization by one or more other employees, etc. The goals field 960 identifies goals for the employee. These goals may be generated by the employee, a supervisor/manager of the employee, automatically generated, etc. The skills gap field 962 identifies one or more gaps in skills, based on goals and/or feedback provided by the employee, a manager/supervisor, someone else within the organization, organization policies, comparison between the employee and his or her peers, and so forth. The feedback field 964 may include feedback from a manager, a supervisor, the employee, or some other person in the organization. As with the skill records 900 of FIG. 10A, it should be understood that the employee records 950 shown in FIG. 10B are merely examples and that embodiments are envisaged in which the fields have different values, the records have additional fields, fewer fields, and/or different fields.

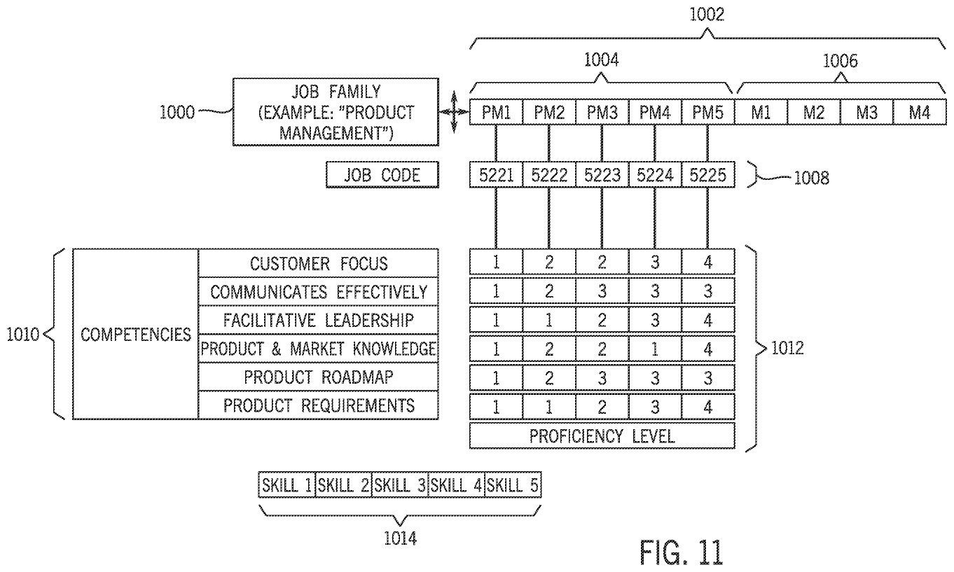

FIG. 11 is a visualization of data stored in the skills ontology for a job family called “product management” 1000. As shown, the product management job family 1000 includes a set of jobs 1002, including product manager (PM) jobs 1004 and manager (M) jobs 1006. The PM jobs 1004 (e.g., PM1, PM2, PM3, PM4), correspond to different levels of product management (PM), the M jobs 1006 correspond to different levels of manager jobs, and the number in each job name corresponds to respective a level of the job. Accordingly, as shown in FIG. 11, the jobs listed increase in seniority from left to right. Job codes 1008 for each of the PM jobs 1004 are shown below the respective PM jobs 1004, connected by a series of lines.

A series of competencies 1010 for the jobs 1002 are listed, including, for example, customer focus, communicates effectively, facilitative management, product and marketing knowledge, product roadmap, product requirements. Next to each competency is a proficiency score for each of the PM jobs 1004. Accordingly, the proficiency score for each competency is indicative of an expected level of proficiency of a person holding the respective job. For example, the organization would expect someone holding the PM1 job to have a proficiency score of 1 in customer focus, someone holding the PM2 job to have a proficiency score of 2 in customer focus, someone holding the PM3 job to have a proficiency score of 2 in customer focus, someone holding the PM4 job to have a proficiency score of 3 in customer focus, and someone holding the PM5 job to have a proficiency score of 4 in customer focus. FIG. 11 also shows a collection of skills 1014 one holding the jobs 1002 is expected to have. The skills 1014 listed may be skills for all of the jobs, or skills for a specific selected job. In some embodiments, the listed skills 1014 may be directly or indirectly related to the listed competencies 1010. However, in other embodiments, the listed skills 1014 may be entirely different from and unrelated to the listed competencies 1010, or some combination thereof. It should be understood however, that FIG. 11 is merely illustrative of an example and that embodiments for different job families, different jobs having different job codes, different competencies, different distributions of proficiency levels, and different skills are envisaged.

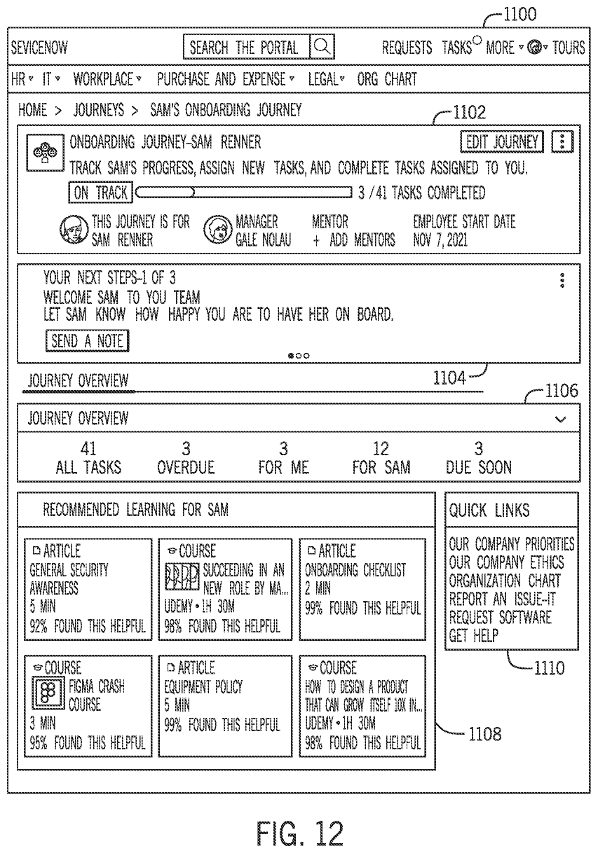

FIG. 12 is an example employee-focused manager dashboard 1100 for a manger within an organization that is populated based on data stored in a skills ontology. As shown, the employee-focused manager dashboard 1100 includes a top section 1102, a next steps section 1104, a reporting section 1106, a recommendation section 1108, and a quick links section 1110. The top section 1102 identifies a specific employee being managed, the employee's manager, any mentors that have been assigned to the employee, the employee's start date, a task progress bar and an indication of whether the employee is ahead of schedule, on track, or behind schedule.

The next steps section 1104 includes recommended actions that can be taken by the manager. For example, in FIG. 12, the recommendation is to send the employee a note welcoming the employee to the manager's team. Other recommended actions may include, for example, requesting a meeting, assigning a task, assigning training, asking a question, etc.

The reporting section displays statistics for the employee, including, for example, assigned tasks, overdue tasks, tasks for the manager, tasks for the employee, tasks due soon, and so forth. The statistics shown in FIG. 12 are displayed when a “journey overview” tab is selected. However, the employee-focused manager dashboard 1100 may also include “activity” and “attachments” tabs. The activity tab may include more information about assigned tasks or training being completed. The attachment tab may be used to access shared documents, images, visualizations, etc.

The recommendation section 1108 includes recommended training materials that the manager can select to assign to the employee. The quick links section 1110 may include a series of links to common pages or documents, such as, company priorities, company ethics, an organizational chart, an IT reporting page, a software request, a help page, etc.

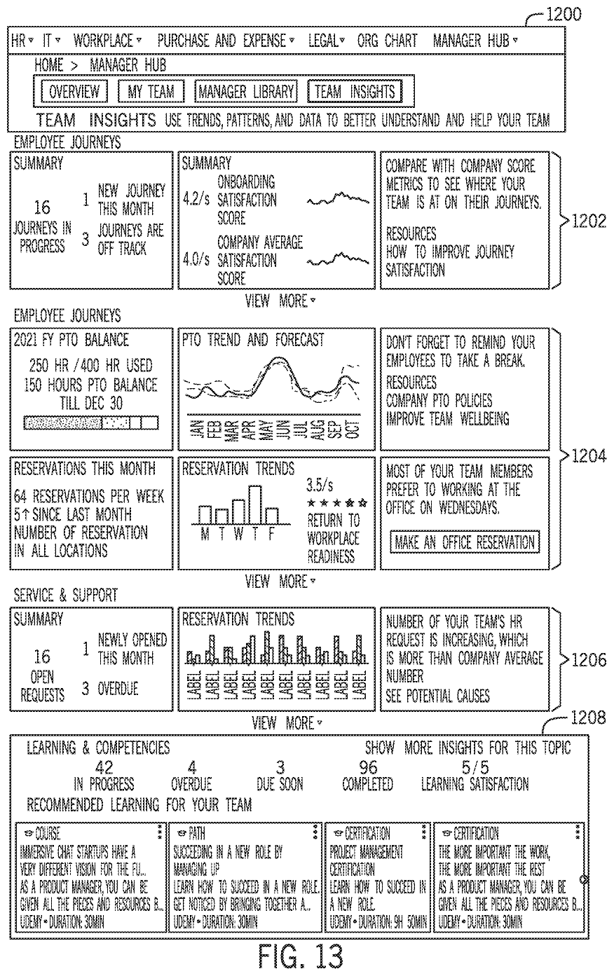

FIG. 13 is an example team-focused manager dashboard 1200 for a manger within an organization that is populated based on data stored in a skills ontology. The team-focused manager dashboard 1200 includes an employee journeys section 1202, a when and where your team is working section 1204, a service and support section 1206, and a learning and competencies section 1208. The employee journeys section 1202 provides information (e.g., statistics, metrics, visualizations, etc.) about how the team the manager manages are progressing along their training/development track. For example, as shown in FIG. 13, the employee journeys section 1202 displays the number of journeys in progress, the number of new journeys this month, the number of journeys that are ahead of schedule, on track, or off track, a team-specific onboarding/journey satisfaction score, a company-wide onboarding/journey satisfaction score, time series plots of the team-specific onboarding/journey satisfaction score and the company-wide onboarding/journey satisfaction score, and recommended resources for improving satisfaction scores.

The when and where your team is working section 1204 provides the manager with information about the times during the day that their team is working, whether the team is working at a specific location, from home, or from some other remote location, paid time off (PTO) usage, statistics and visualizations for reservations for workspace, an option reserve workspace, and so forth. The service and support section 1206 provides the manager with information about service request from within his or her team including, for example, number of open requests, number of new requests, number of overdue requests, request data per month, and so forth.

The learning and competencies section 1208 includes information about the progress of the manager's team in performing assigned training. For example, the learning and competencies section 1208 may include number of training assignments in progress, number of overdue training assignments, number of training assignments due soon, number of completed training assignments, employee satisfaction with training assignments, and recommended training assignments for the team. Though the manager dashboards 1100, 1200 shown in FIGS. 12 and 13 are for a manager, it should be understood that similar dashboards may be generated for employees, directors, HR team members, training team members, learning and development managers, vice presidents, executives, and so forth.

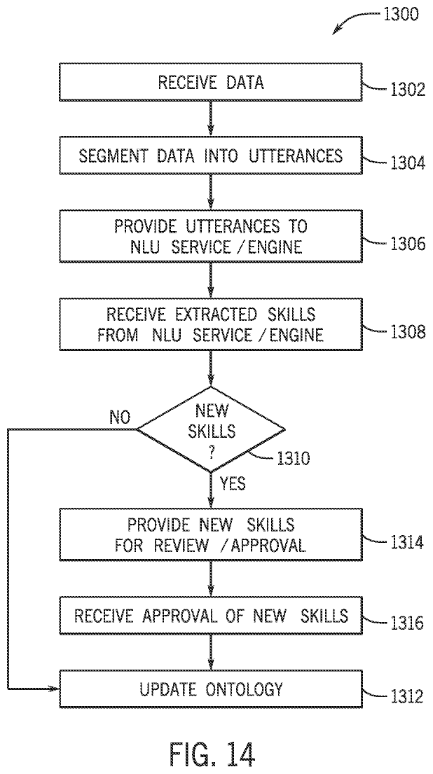

FIG. 14 is a flow chart of a process 1300 for extracting skills from received data and updating a skills ontology. At block 1302, data is received. The received data may be internal data (e.g., data generated within an organization based on tasks performed, training completed, manually entered data, communication, projects completed, closed incidents/tickets, recommendations of others, certifications obtained, etc.) or external data (e.g., data from third parties, publicly available data, data purchased or subscribed to via a service provider, data from public databases, data from private or public research, data scraped from the internet, etc.). In some embodiments, data may be pre-processed to convert the data into a more usable form.

At 1304, the data is segmented into utterances. Utterances may include data representative of character strings that form one or more paragraphs, one or more sentences, one or more words, etc. In some embodiments, machine learning and/or an NLU engine may be used determine how to segment the data such that related words, phrases, and/or sentences stay together. In some embodiments, segmenting the data into utterances may involve clustering data.

At 1306, the utterances are provided to an NLU service or engine. In some embodiments, and organization may be running an NLU engine on premises (“on-prem”) that processes the utterances. In other embodiments, the utterances may be transmitted to the cloud, transmitted to a remote server, and/or transmitted to a service provider for analysis. As previously described, the NLU service/engine utilizes NLU techniques to extract entities from the utterances and then identify skills within the extracted entities. Identifying skills may be based on analyzing and/or comparing generated vectors, referencing a skills database, using surrounding words and usage as context, and so forth.

For example, in one embodiment, extracted entities may be tagged as belonging to certain categories of entities (e.g., people, places, locations, skills, etc.). In such an embodiment, extracted entities that are related to skills may be manually tagged as a “skills entity”. The manually tagged entities may be used as training data to train a machine learning model to tag entities extracted from data sources (e.g., resumes, HR profiles, social media data, task data, etc.) as belonging to certain categories. For example, the trained machine learning model may be able to recognize extracted entities as related to skills and then tag those extracted entities as skills entities. Further, the trained machine learning model may be used to parse a corpus of data to infer, predict, and/or classify keywords or other character strings in the corpus as representing or otherwise associated with skills entities. The skills entities may then be assigned to or otherwise associated with an employee profile.

In other embodiments, completed task data may be parsed and action verbs identified in the completed task data. The identified action verbs may be assigned scores and then clustered based on assigned scores using sets of rules and/or thresholds. The action verbs may be presented to a reviewer as candidate skills entities for verification. The verified skills entities and corresponding clusters of action verbs may be used as a training data set to train an NLP model to automatically identify skills entities in other sets of data.

At 1308, the extracted skills are received from the NLU service/engine. At 1310, the extracted skills are compared to skills stored in a skills ontology to determine whether any new skills were extracted that were not found in the ontology. If no new skills were extracted, the process 1300 proceeds to 1312 and updates the ontology based on the extracted skills. For example, if an employee completed a training about how to write more modular computer code, the ontology may be updated to reflect that employee's related skills are improving.

If new skills were extracted, the process 1300 proceeds to 1314 and provides the new skills for review/approval. If the new skill is approved, the approval is received at 1316. However, in some embodiments, new skills may be automatically approved, or the approval may be skipped if the new skills meet certain specified criteria. For example, if an employee creates a blog post about a niche topic that is not of significant import to the organization's business, a new skill may be automatically approved and it may be assumed that the employee has some knowledge of that topic. However, if one of the new extracted skills is based on data that an employee has obtained a new, as yet unrecognized professional certification that is of significance to the organization's business, a policy may be put in place that updating the ontology to reflect the new skill is dependent upon the skill being investigated and approved by a reviewer. The process 1300 proceeds to 1312 and updates the ontology based on the extracted skills.

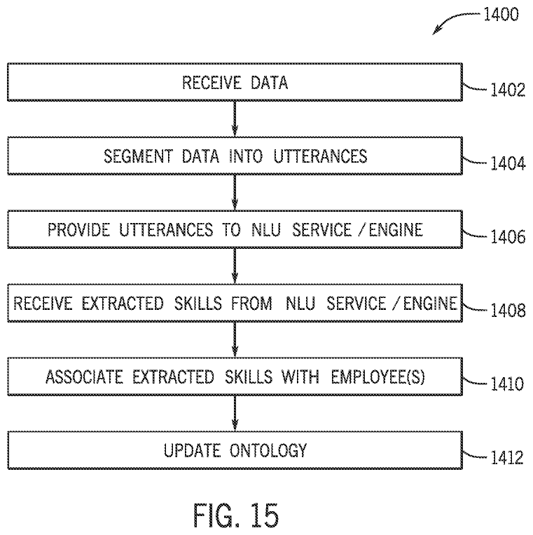

FIG. 15 is a flow chart of a process 1400 for extracting skills from received data and associating the extracted skills with employees. At block 1402, data is received. The received data may be internal data (e.g., data generated within an organization) or external data (e.g., data generated by one or more entities outside of the organization). In some embodiments, data may be pre-processed to convert the data into a more usable form.

At 1404, the data is segmented into utterances that may include one or more paragraphs, one or more sentences, one or more words, etc. In some embodiments, machine learning and/or an NLU engine may be used determine how to segment the data such that related words, phrases, and/or sentences stay together. In some embodiments, segmenting the data into utterances may involve clustering data.

At 1406, the utterances are provided to an NLU service or engine, which may be running on-prem, in the cloud, on a remote server, and/or on a device managed by a service provider. The NLU service/engine utilizes NLU techniques to extract entities from the utterances and, in some cases, identify skills within the extracted entities. Identifying skills may be based on analyzing and/or comparing generated vectors, referencing a skills ontology, referencing a skills database, using surrounding words and usage as context, and so forth. At 1408, the extracted entities/skills are received from the NLU service/engine.

At 1410, the extracted skills are associated with an employee. In some embodiments, the employee may be identified by one of the entities extracted from the data. In other embodiments, the employee may be identified in the data, identified as a source of the data, identified by one or more pieces of characteristic information, and so forth. At 1412, the skills ontology is updated to reflect that the identified employee has the extracted skills. In some embodiments, the extracted skills, or the other entities extracted by the NLU service/engine may be indicative of the employee's proficiency at the skill.

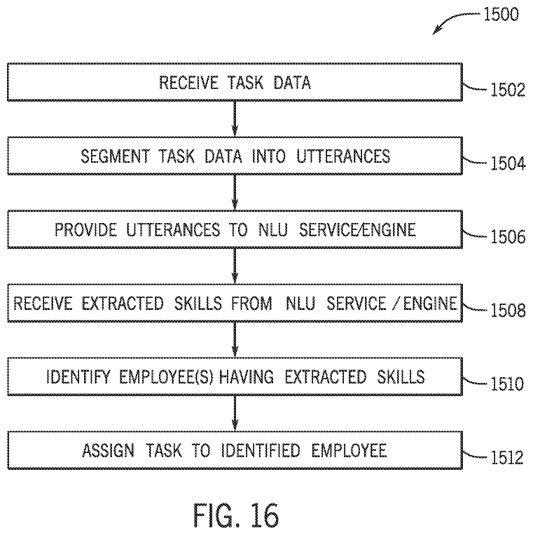

FIG. 16 is a flow chart of a process 1500 for extracting skills from tasks and assigning tasks to employees. At block 1502, task data associated with a task to be performed is received. The received data may be internal data (e.g., data generated within an organization) or external data (e.g., data generated by one or more entities outside of the organization). In some embodiments, data may be pre-processed to convert the data into a more usable form.

At 1504, the data is segmented into utterances that may include one or more paragraphs, one or more sentences, one or more words, etc. In some embodiments, machine learning and/or an NLU engine may be used determine how to segment the data such that related words, phrases, and/or sentences stay together. In some embodiments, segmenting the data into utterances may involve clustering data.

At 1506, the utterances are provided to an NLU service or engine, which may be running on-prem, in the cloud, on a remote server, and/or on a device managed by a service provider. The NLU service/engine utilizes NLU techniques to extract entities from the utterances and, in some cases, identify skills within the extracted entities that may be used to perform the task. Identifying skills may be based on analyzing and/or comparing generated vectors, referencing a skills ontology, referencing a skills database, using surrounding words and usage as context, and so forth. At 1508, the extracted entities/skills are received from the NLU service/engine.

At 1510, the process 1500 references the skills ontology to identify one or more employees having the extracted skill. If multiple employees have the extracted skill, the process 1500 may consider the various proficiencies of the employees possessing the extracted skill, the availability of the employees possessing the extracted skill to perform the task during a given time, how many assigned tasks each of the employees possessing the extracted skill have in their respective queues, and so forth. If no employees are found to have the extracted skill, the process 1500 may identify one or more related skills and identify one or more employees having the related skill. At 1512, the task is assigned to the selected employee possessing the extracted skill. If the selected employee declines the task, the process 1500 may assign the task to another employee that has not previously declined the task. In some embodiments, the process 1500 may monitor the task through completion and, upon completion, update the skills ontology to reflect the improved proficiency of the employee by performing the task.

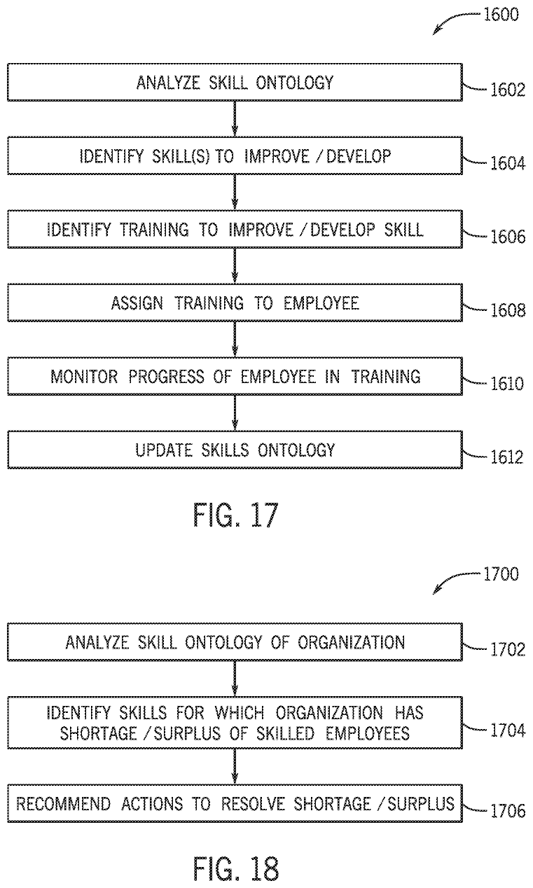

FIG. 17 is a flow chart of a process 1600 for developing a training program for employees. At 1602, the skill ontology for an employee is analyzed. At 1604, one or more skills the employee could improve or develop further are identified. This may be referred to, for example, as a skills gap. A skills gap may be determined by comparing an employee to his or her goals, comparing the employee to his or her peers, comparing the employee to one or more previous employees that traveled a similar trajectory, comparing the employee to a target trajectory, and so forth.

At 1606, training is identified to improve/develop the identified skill and close the skills gap. Training may be identified, for example, by referencing the skills ontology, referencing a training database, referencing internal training materials, based on the recommendation of a learning and development manager, etc. At 1608, the training is assigned to the employee. In some embodiments, at 1610, the progress of the employee may be monitored while the employee completed the training. Once the assigned training is completed, or even partially complete, at 1612, the skills ontology may be updated to reflect that the training has been completed.

FIG. 18 is a flow chart of a process 1700 for identifying and addressing skill shortages and/or surpluses in an organization. At 1702, the skill ontology for an organization or division/group/team within the organization is analyzed. At 1704, one or more skills for which the organization has a shortage or surplus of skilled employees are identified. For example, the organization may have too many developers or engineers of a particular type based on past product development cycles, a shift in priorities at the organization, etc. Alternatively, the organization may have had employees leave certain positions for jobs at other organizations, to retire, to go to graduate school, etc. At 1706, one or more actions are identified and recommended to resolve the shortage or surplus. These recommendations may include, for example, promoting certain employees, assigning training to certain employees, transferring certain employees to other jobs, terminating employees, identifying certain employees as potential candidates for certain jobs, etc. In some embodiments, the recommendations may be provided to a manager, supervisor, executive, etc. for review. The reviewer may then take action within the GUI to implement certain recommended actions, initiate recommended actions, request that recommended actions be initiated, etc.

The present disclosure is directed to generating, maintaining, and utilizing a skills ontology. The skills ontology includes classes of data that define skills possessed or demonstrated by employees of an enterprise. Specifically, sets of internal data (e.g., data generated within the organization) and/or external data (data generated outside of the organization) may be received and segmented into strings of text referred to as utterances. The utterances may be provided to an NLU service/engine, which uses NLU techniques to process the utterances to extract intents and/or entities. Skills may be identified from within the extracted entities. If extracted skills had not previously been included in the skills ontology, records for the new skills may be created and included in the ontology. If the received data is representative of actions that have been performed, or other activity that has occurred in the past, the skills ontology may be updated based on the skills extracted from the received data by associating the extracted skills with employees that performed the actions. This may include, for example, updating a skills profile for the employee within the skills ontology. If the data is representative of tasks to be performed, the skills ontology may be utilized to identify employees having the extracted skills and assign the task to one or more employees for completion. Once the task as been completed, the skills profiles of the one or more employees in the skills ontology may be updated to reflect performance of the task. Further, the skills ontology may be used to identify skills gaps or areas for improvement for an employee, assign training for the identified skills, monitor when the training has been completed, and then update the skills profile of the employee in the skills ontology to reflect completion of the training. The skills ontology may also be utilized to identify skills shortages and/or skills surpluses within the enterprise so that decisions can be made to move some employees to different jobs, promote some employees, demote some employees, create new jobs to be filled, terminate certain jobs, train existing employees to assume different jobs, and so forth. Accordingly, the disclosed techniques utilize NLU techniques to extract skill data from available data and utilize the skill data to increase the efficiency of some of the enterprise's operations.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a processor; and
a memory, accessible by the processor, the memory storing instructions that, when executed by the processor, cause the processor to perform operations comprising:
receiving a data set;
segmenting the data set into a plurality of utterances;
extracting, via a natural language understanding (NLU) engine, a plurality of entities from the plurality of utterances;
identifying a plurality of skills referenced within the plurality of entities;
determining that one or more of the plurality of identified skills do not appear in a skills ontology for an organization; and
in response to determining that the one or more of the plurality of identified skills do not appear in the skills ontology, generating a new record in the skills ontology for each of the one or more of the plurality of identified skills that do not appear in the skills ontology.

2. The system of claim 1, wherein the operations comprise:
receiving an additional data set representative of an action that has been performed by an employee of the organization;
segmenting the additional data set into an additional plurality of utterances;
extracting, via the NLU engine, an additional plurality of entities from the additional plurality of utterances;
identifying one or more additional skills within the additional plurality of entities; and
updating the skills ontology to associate the one or more additional skills with the employee of the organization.

3. The system of claim 1, wherein the operations comprise:
receiving a further data set representative of an action to be performed;
segmenting the further data set into a further plurality of utterances;
extracting, via the NLU engine, a further plurality of entities from the further plurality of utterances;
identifying one or more further skills within the further plurality of entities;
referencing the skills ontology to identify an employee of the organization as possessing the one or more further skills; and
assigning the action to be performed to the identified employee of the organization.

4. The system of claim 1, wherein the operations comprise:
transmitting a request for an approval to add the new records to the skills ontology for each of the one or more of the plurality of identified skills that do not appear in the skills ontology; and
receiving a response to the request indicative of the approval to add the new records to the skills ontology for each of the one or more of the plurality of identified skills that do not appear in the skills ontology.

5. The system of claim 1, wherein extracting the plurality of entities from the plurality of utterances comprises:
generating, for each utterance of the plurality of utterances, a respective utterance tree, wherein each respective utterance tree is representative of a respective syntactic structure of the utterance and comprises a respective plurality of nodes, wherein each node comprises a word vector that corresponds to a respective word of the utterance;
comparing the utterance trees and the word vectors to one or more dictionaries, one or more tree vector ontologies, one or more word vector ontologies, one or more tree vector databases, or one or more word vector databases, or any combination thereof, to extract a plurality of intents and the plurality of entities; and
outputting the extracted plurality of entities.

6. The system of claim 1, wherein identifying the plurality of skills within the plurality of entities comprises referencing the skills ontology, referencing a skills database, referencing one or more databases, or comparing respective word vectors for the plurality of entities to a plurality of known word vectors, or any combination thereof.

7. The system of claim 1, wherein the new record in the skills ontology identifies one or more related skills, wherein the one or more related skills comprise, one or more parent skills, one or more child skills, or one or more sibling skills, or any combination thereof.

8. The system of claim 1, wherein the data set comprises internal data generated within the organization.

9. The system of claim 1, wherein the data set comprises external data, wherein the external data is purchased from a data source, obtained from a public data source, obtained from a data source to which the organization subscribes.

10. A method, comprising:
receiving a data set, wherein the data set is representative of an action performed by an employee of an organization;
segmenting the data set into a plurality of utterances;
providing the plurality of utterances to a natural language understanding (NLU) engine;
receiving, from the NLU engine, a plurality of entities extracted from the plurality of utterances;
identifying one or more skills within the plurality of entities; and
updating a skills ontology for the organization to associate the one or more identified skills with the employee that performed the action.

11. The method of claim 10, comprising:
referencing the skills ontology to identify a plurality of skills possessed by the employee, including the one or more skills, and respective proficiency levels of the employee at each of the plurality of skills;
identifying a skills gap for the employee by comparing the respective proficiency levels of the employee at each of the plurality of skills to one or more goals, one or more other employees, or one or more target proficiency levels, or any combination thereof;
identify one or more training activities to address the identified skills gap; and
assigning the one or more training activities to the employee.

12. The method of claim 11, comprising:
monitoring the employee's progress in completing the one or more training activities; and
updating the skills ontology based upon the employee completing one or more training activities being completed.

13. The method of claim 10, wherein updating the skills ontology to associate the one or more identified skills with the employee that performed the action comprises updating the skills ontology to include the employee's proficiency level at the one or more identified skills.

14. The method of claim 10, wherein the skills ontology comprises a profile for the employee that identifies a plurality of skills demonstrated by the employee, including the one or more identified skills, and the employee's proficiency level at each of the plurality of skills.

15. The method of claim 14, comprising:
generating a graphical user interface (GUI) comprising a representation of the plurality of skills demonstrated by the employee; and
transmitting the GUI for display by a computing device.

16. A non-transitory, computer readable medium comprising instructions that, when executed by a processor, cause the processor to perform operations comprising:
receiving a data set, wherein the data set is representative of a task to be performed;
segmenting the data set into a plurality of utterances;
generating, via a natural language understanding (NLU) engine, for each utterance of the plurality of utterances, a respective utterance tree, wherein each respective utterance tree is representative of a respective syntactic structure of the utterance and comprises a respective plurality of nodes, wherein each node comprises a word vector that corresponds to a respective word of the utterance;
comparing, via the NLU engine, the utterance trees and the word vectors to one or more dictionaries, one or more tree vector ontologies, one or more word vector ontologies, one or more tree vector databases, or one or more word vector databases, or any combination thereof, to extract a plurality of intents and the plurality of entities;
identifying one or more skills within the plurality of entities by referencing a or skills ontology, referencing a skills database, referencing one or more databases, or comparing respective word vectors for the plurality of entities to a plurality of known word vectors, or any combination thereof;
referencing the skills ontology for an organization to identify an employee of the organization having the one or more identified skills; and
assigning task to the employee of the organization having the identified one or more skills.

17. The non-transitory, computer readable medium of claim 16, wherein the skills ontology comprises respective records for the one or more identified skills, wherein each of the respective records identifies one or more related skills, wherein the one or more related skills comprise, one or more parent skills, one or more child skills, or one or more sibling skills, or any combination thereof.

18. The non-transitory, computer readable medium of claim 16, wherein the skills ontology comprises a profile for the employee that identifies the employee's proficiency at the one or more identified skills.

19. The non-transitory, computer readable medium of claim 16, wherein the operations comprise:
receiving an indication that the task has been completed; and
updating the skills ontology for the organization to reflect completion of the task, improved proficiency at the one or more identified skills for the employee, or both.

20. The non-transitory, computer readable medium of claim 16, wherein the operations comprise:
determining that a plurality of employees of the organization, including the employee, have the one or more identified skills; and
referencing the skills ontology to determine that the employee is most proficient of the plurality of employees at the one or more identified skills.
